(19) United States
(12) Patent Application Publication
(10) Pub. No.: US 2025/0127192 A1
(43) Pub. Date: Apr. 24, 2025

(54) WET PET FOOD SYSTEMS

(71) Applicant: Société des Produits Nestlé S.A., vevey (CH)

(72) Inventors: Pascal Vanacker, AMIENS (FR); Isabelle Lescieux, Aubigny (FR); Pascale CAREL, Sailly-le-sec (FR); Anne-Charlotte Philippe, Amiens (FR)

(73) Assignee: Société des Produits Nestlé S.A., vevey (CH)

(21) Appl. No.: 18/889,655

(22) Filed: Sep. 19, 2024

Related U.S. Application Data
(60) Provisional application No. 63/592,640, filed on Oct. 24, 2023.

(51) Int. Cl. A23K 30/00; A23K 10/20; A23K 10/30; A23K 50/48; B65B 25/00; B65D 81/24

(52) U.S. Cl. CPC A23K 30/00; A23K 10/20; A23K 10/30; A23K 50/48; B65B 25/001; B65D 81/24

(57) ABSTRACT

The present disclosure is drawn to wet pet food systems and methods of packaging wet pet foods. The wet pet food systems include a sealed pouch constructed of a monomaterial of polypropylene and a wet pet food contained within the sealed pouch. The wet pet food can include a member selected from the group consisting of a mousse, a chunk-in-loaf, and chunks-in-gravy. The wet pet food includes an antioxidant including a soy sauce.

### CROSS REFERENCE TO RELATED APPLICATION

This application claims the benefit of and priority to U.S. Provisional Application Ser. No. 63/592,640 filed Oct. 24, 2023, the disclosure of which is incorporated in its entirety herein by this reference.

### BACKGROUND

The preparation and packaging of wet pet foods with a reasonably long shelf life can be a challenge, particularly when packaging may be somewhat permeable to water and/or oxygen during storage. For example, oxidation of the wet pet food may occur, particularly at the surface where the wet pet food comes in direct contact with the packaging material. The solution has been to use multi-layered pouches or bags with an oxygen and/or moisture vapor barrier, such as a thin layer of aluminum, e.g., sometimes referred to as an alu-pouch. However, alu-pouches and other pouches of multiple materials can be difficult to recycle due to the compositing of the various layers into unified layers. On the other hand, by selecting a single recyclable material for use as a pouch or container introduces challenges related to their permeability to various gases, such as oxygen and/or water vapor.

### DETAILED DESCRIPTION

In accordance with the present disclosure, a pet food system can include a sealed pouch constructed of a monolayer of polypropylene and a wet pet food contained within the sealed pouch. The wet pet food can be in the form of a member selected from the group consisting of a mousse, a chunk-in-loaf, and chunks-in-gravy. Furthermore, the wet pet food can include an antioxidant including a soy sauce. In some examples, the sealed pouch can be recyclable. In other examples, the sealed pouch does not include an additional fluid barrier to assist with reducing oxygen or water permeability into the sealed pouch. Thus, even when the sealed pouch is more permeable to oxygen and water than to an aluminum barrier pouch, the presence of the soy sauce provides long-term storage protection while the wet pet food is contained within the sealed pouch. For example, the wet pet food may be shelf stable within the sealed pouch for at least about nine months (or much longer). In other examples, the soy sauce may be included in the wet pet food at from about 0.1 wt % to about 3 wt % based on dehydrated soy sauce weight within a total weight of the wet pet food. The soy sauce can alternatively be added to the wet pet food at from about 0.25 wt % to about 2 wt % based on dehydrated soy sauce weight within a total weight of the wet pet food. In other examples, the wet pet food can include from about 40 wt % to about 80 wt % water based on a total weight of the wet pet food. In a more specific example, the wet pet food can be in the form of the chunks-in-gravy, and the chunks-in-gravy can include chunks, e.g., such as chunks containing protein, and a gravy present in the sealed pouch at a weight ratio from about 1:1 to about 1:4, or at a weight ratio from about 2:3 to about 1:3. The chunks, for example, can include from about 30 wt % to about 80 wt % protein, such as animal-based protein and/or plant-based protein, e.g., plant protein extract. In other examples, the antioxidant present in the wet pet food can consist or consists essentially of the soy sauce. In still other examples, the wet pet food can include Maillard reaction precursors or ingredients and a catalyst.

A method of packaging wet pet food can include preparing a wet pet food that includes a member selected from the group consisting of a mousse, a chunk-in-loaf, and chunks-in-gravy. The wet pet food prepared can also include an antioxidant including a soy sauce. Furthermore, the method can include enclosing the wet pet food within a sealed pouch constructed of a monolayer of polypropylene. In some examples, the soy sauce can be included in the wet pet food at a sufficient concentration to substantially offset visible oxidation that would otherwise be caused by oxygen and water permeability of the sealed pouch. In other examples, preparing the wet pet food can include adding the soy sauce as dehydrated particulates at from about 0.1 wt % to about 3 wt % based on a total weight of the wet pet food. In other examples, no other antioxidant is added to the wet pet food other than the soy sauce. In still other examples, the wet pet food may be in the form of the chunks-in-gravy and can be prepared by admixing chunks with a gravy at a weight ratio from about 1:1 to about 1:4. In this example, the gravy can include water, thickener, and the antioxidant (which includes at least the soy sauce).

It is noted that when discussing examples related to the wet pet food systems and the methods of packaging wet pet foods described herein, such discussions can be considered applicable to one another whether or not they are explicitly discussed in the context of that example. Thus, for example, when discussing the “sealed pouch” in the context of the wet pet food systems, such disclosure is also relevant to and directly supported in the context of the methods of packaging wet pet foods, and vice versa.

Furthermore, terms used herein will have their ordinary meaning in the relevant technical field unless specified otherwise. In some instances, there are terms defined more specifically throughout the specification, with a few more general terms included at the end of the specification. These more specifically defined terms have the meaning as described herein.

### Wet Pet Food Systems

The wet pet food systems of the present disclosure include a sealed pouch or bag constructed of a monolayer of polypropylene and a wet pet food contained within the sealed pouch. Regarding the sealed pouch in particular, there has been a trend toward the recyclability of packaging. However, recyclability can be a challenge when multiple materials are used in a composited form, such as may be the case with various plastics composited with gas or moisture vapor barriers. More specifically, in some packaging systems designed to preserve wet pet food, there have been multi-layered pouches including various polymers composited with a thin aluminum barrier in the form of an “alu-pouch” to prevent oxygen and/or water vapor infiltration that may lead to oxidation of the contents carried by the packaging. This can be a good solution with respect to wet food preservation, but is difficult to recycle as the alu-pouch materials would typically need to be separated to recycle the polymer material. On the other hand, moving to a monolayer polymer for packaging (that does not include a separate vapor barrier) may provide a better solution for recyclability, but these materials tend to have an oxygen transmission rate (OTR) and/or a moisture vapor transmission rate (MVTR) that may not preserve the wet pet food contained therein. For example, the transmission of oxygen and/or water vapor across the packaging can lead to oxidation of the wet pet food contained therein, particularly at the surface of the wet pet food within the packaging that is in immediate contact with the inner surface of the packing material. Thus, it has been recognized that by combining a certain type of polymeric packaging that is susceptible to some vapor transmission with certain antioxidants incorporated into wet pet food contents, the long term challenges associated with wet pet food storage can be ameliorated while retaining the ability of providing fully recyclable packaging.

In accordance with this, the sealed pouches described herein can be a monomaterial of polypropylene. Even though polypropylene may otherwise exhibit some degree of oxygen and water vapor transmission, when combined with the wet pet food recipes described herein, the polypropylene packaging is sufficiently resistant to oxygen and water vapor transmission that the wet pet food contained therein can be packaged and stored long term, e.g., at least 9 months and typically much longer. The term “monomaterial” refers to packaging that includes only polypropylene, even if the packaging includes multiple layers of polypropylene, provided the multiple layers of polypropylene can be recycled together without layer separation. That stated, in some examples, the polypropylene may be in the form of a monolayer of polypropylene. It is noted that the term “monomaterial” would exclude any labeling that may be affixed to the polypropylene packaging that may be present for purposes of customer identification of the product, nutritional information, branding, etc.

Typically, the scaled pouch of polypropylene may be formed to be flexible, and may be a single serving pouch or may include multiple servings with the ability to reseal the pouch after opening, e.g., zip lock or other technology.

The thickness of the polypropylene pouch can be any thickness suitable to effectively contain the wet pet food, but for practical purposes, the thickness may typically be from about 90 μm to about 120 μm, from about 100 μm to about 110 μm, and more typically from about 102 μm to about 106 μm. A thicker polypropylene pouch may permit less oxygen and/or water vapor transmission, but relatively thin packaging can still be effective when the appropriate antioxidant is included as part of the wet pet food recipe or formulation. In some examples, without being limited by these ratios, the polypropylene pouch can have an inner surface area from about 150 cm² to about 250 cm², from about 180 cm² to about 230 cm², or from about 200 cm² to about 220 cm². The inner volume, for example, can be from about 60 cm³ to about 110 cm³, from about 70 cm³ to about 100 cm³, or from about 80 cm³ to about 90 cm³. At these inner surface areas and inner volumes, the amount of wet pet food that contacts the inner surface of the polypropylene pouch can be retained within a reasonable level. Notably, other inner surface areas and/or inner volumes can likewise be used. Regardless, the antioxidant of the wet pet food is typically admixed throughout the wet pet food so that ratios outside of this range can likewise be used.

Referring now to the wet pet food that is contained in the sealed pouch, which is constructed of the monomaterial polypropylene, it has been recognized that the inclusion of soy sauce as the antioxidant within the wet pet food recipe or formulation performed particularly well for purposes of long term storage. Surprisingly, many known antioxidants that were thought would perform well within the polypropylene pouches described herein did not perform nearly as well as soy sauce as the antioxidant. For example, other anti-oxidant solutions, such as solutions containing vitamin C, vitamin E, Digest, carrot, tomato, cranberry, Maillard reaction precursors, e.g., glycine, xylose and dextrose, and/or meat hydrolysates did not perform nearly as well as the soy sauce antioxidant when stored in a monolayer of polypropylene for long periods of time. Without the soy sauce being present, even with other anti-oxidants, wet pet foods after prolonged storage time exhibited change in color (particularly adjacent to the inner surface of the pouch), and in many cases, the palatability to animals tested was decreased.

There are many forms of wet pet food that can be incorporated into the wet pet food systems of the present disclosure. The term “pet food” means any composition formulated to be consumed by a pet, whereas, the term “wet pet food” refers to pet foods that include more than about 20 wt % moisture or a water activity higher than 0.75, and often both. Example wet pet foods that can be used include mousses, chunk-in-loaf, chunks-in-gravy, and the like. With respect to the wet pet food described herein, the term “pet” refers to domesticated or other animals that are kept by humans as companion animals, such as avian; equine; feline; canine; rodent, e.g., hamsters, guinea pigs, mice, gerbils, etc.; lagomorph, e.g., rabbits; ferrets; cattle; goats; sheep; donkeys; pigs, etc.

The term “chunk-in-loaf” can also be referred to as “HsCC,” “Heat Set Chunk Compound,” or “terrine,” which may be used interchangeably. Typically, a chunk-in-loaf product is in the form of a loaf product with chunks added. The term “chunks-in-gravy” refers to chunks combined with a gravy.

Chunks-in-gravy may include “grilled chunks,” “steamed chunks,” or the like, and often have the appearance of grilled meat and are made by one or more of the methods disclosed in U.S. Pat. Nos. 10,993,445 and 10,470,470, which are incorporated herein by reference in their entireties, with an example including the commercial product FANCY FEAST® (“FF”).

The term “grilled chunks-in-gravy” refers to grilled chunks combined with a gravy, and the term “steamed chunks-in-gravy” refers to steamed chunks combined with gravy.

The term “chunks” refers to a plurality of separate food bodies, which are typically meat pieces or restructured meat pieces which may have a pellet shape and often simulate real meat chunks. The chunks may contain one or more of meat, meat by-products, cereals, or vegetable proteins. Non-limiting examples of chunks include particulates, pellets, pet food pieces, dehydrated meat, meat analog, vegetables, or combinations thereof. Other examples include pet snacks, such as meat or vegetable jerky, rawhide, or biscuits. The chunks may vary in size depending upon the animal that will consume the product, e.g., the type, age, health, or size of the animal. For example, chunk sizes for cats may range from 3 mm to 30 mm, or from about 8 mm to 20 mm, determined by measurement along the longest side of the chunk. In some instances, the chunks may include wheat gluten, and furthermore, may include one or more of meat, fish, or animal meals. In some examples, the chunks can include from about 30 wt % to about 80 wt % protein, such as animal-based protein and/or plant-based protein, e.g., plant protein extract.

A “gravy” can include a flowable edible composition that typically includes water and a thickener, such as one or more of a starch or a gum. In some examples, a gravy is in the form of a gel or a sol. For example, wet pet foods as described herein can be prepared to have a viscosity suitable for filling the polypropylene pouches. Thus, gravy can be formulated with a hydrocolloid/starch system with at least about 1 wt % hydrocolloid/starch content, and more typically at least about 2 wt % or at least about 3 wt % hydrocolloid/starch content.

When referring to a “loaf” or “mousse,” these terms can be used interchangeably herein. A loaf may be a shaped or molded mass of pet food that is typically substantially homogeneous. A loaf may have a structure that maintains, during and after removal from the packaging at ambient temperature and ambient pressure, the shape or substantial shape imparted by the packing on the loaf. For example, a loaf removed from a cylindrical can would have a cylindrical shape having a horizontal cross-section with substantially the same dimensions as a corresponding horizontal cross-section of the interior of the can. When removing a loaf from a pouch, a shape may be retained to some degree by the shape of the pouch when the contents are emptied with limited variability.

The terms “pouch(es)” and “bag(s)” can be used interchangeably, and refer to flexible packaging that can be used to package wet pet food in accordance with the present disclosure.

In preparing the wet pet food that is carried by the polypropylene sealed pouch, antioxidant is added that includes soy sauce. Other antioxidants may likewise be added in some examples. However, in one specific example, the only antioxidant added is soy sauce.

A “soy sauce” (sometimes called soya sauce) may refer to a sauce made from fermented soybeans, which includes a protein hydrolysate. The fermented soybeans may be in the form of a paste which can be admixed with other ingredients, depending on the specific soy sauce being made. Furthermore, the term “soy sauce” as used herein may also include soy sauce pastes and/or dehydrated soy sauces which can be added during wet pet food preparation. Dehydrated soy sauce may be hydrated when admixed with the balance of the wet pet food recipe or formulation, as the water content of the wet pet food includes more than about 20 wt % water as defined herein. Notably, the soybeans can be from soybeans or soy flakes, for example, and may include other ingredients, such as wheat/wheat flour or grains, salt or brine, water (which is more prevalent in hydrated forms), Aspergillus oryzae/Aspergillus sojae molds, salt-tolerant yeast, lactic acid bacteria, and/or other ingredients sometimes used in soy sauce formulations. In one example, the soy sauce may include soybeans, wheat, salt, and maltodextrin. In one example, the soy sauce may be Kikkoman Dehydrated Soy Sauce KS-20, which is in the form of a premium soy sauce powder produced from Kikkoman's Naturally Brewed Soy Sauce. Kikkoman soy sauce is dehydrated and concentrated through a spray-drying process. Due to the low temperature and short time processing, the characteristic flavors of this naturally brewed soy sauce can be retained, even when dehydrated into a powder. In some examples, the soy sauce can be selected to avoid one or more of chemically hydrolyzed vegetable proteins (HVP), carbohydrates, chemical preservatives, artificial sweeteners, artificial flavors, or artificial pigments.

By formulating wet pet food to include antioxidant including soy sauce, even when the sealed pouch is more permeable to oxygen and water than an aluminum barrier pouch, the presence of the soy sauce provides long-term storage protection while the wet pet food is contained within the sealed pouch. For example, the wet pet food may be shelf stable within the sealed pouch for at least about nine (9) months (or even much longer).

In examples of the present disclosure, the soy sauce may be included in the wet pet food at from about 0.1 wt % to about 3 wt % based on dehydrated soy sauce weight within a total weight of the wet pet food. The soy sauce can alternatively be added to the wet pet food at from about 0.25 wt % to about 2 wt % based on dehydrated soy sauce weight within a total weight of the wet pet food. In other examples, even though the wet pet foods described herein include more than about 20 wt % water, in a more detailed example, the wet pet food can include from about 40 wt % to about 80 wt % water based on a total weight of the wet pet food. In examples where the wet pet food includes chunks, e.g., such as chunks containing protein, and a gravy, these two components can be present in the sealed pouch at a weight ratio from about 1:1 to about 1:4, or at a weight ratio from about 2:3 to about 1:3. In some examples, when chunks are present, the chunks may include protein at from about 30 wt % to about 80 wt %, and can be in the form of animal-based protein and/or plant-based protein, e.g., plant protein extract. For example, the chunks may include from about 30 wt % to about 80 wt % meat, fish, and/or meat meal (or all three) as the protein content when the chunks are from animal-based protein. As an example, the chunks may include meat and animal products, e.g., 10 wt % to 30 wt % meats including some chicken, pork and/or beef, plant protein extracts, fish and fish by-products, mineral substances, sugars, etc. A specific example of chunks that can be used include those found in the commercial product known as Gourmet Pearl Filettines in Sauce Bags, e.g., pouches, which are available for cats in France.

In still other examples, the wet pet food can be prepared using Maillard reactions, and thus, may include Maillard reaction precursors or ingredients and a catalyst or multiple catalysts. Maillard reaction precursors may be added for any of a number of reasons, such as for aroma development, color generation, or antioxidant activity. The reaction precursors may be included, if present, at from about 0.2 wt % to about 10 wt %, or from about 0.5 wt % to about 5 wt %. There may also be other additives included, such as minerals, vitamins, and/or colorant, e.g., burnt sugar syrup, carotenoids, hemoglobin or the like. These additives may be included independently at from about 0.1 wt % to about 2 wt %.

### Methods of Packaging Wet Pet Foods

The present disclosure also relates to methods of packaging wet pet food. The method can include preparing a wet pet food and enclosing the wet pet food within a sealed pouch. The wet pet food can include a member selected from the group consisting of a mousse, a chunk-in-loaf, and chunks-in-gravy, as previously defined and described. The wet pet food prepared can also include an antioxidant including a soy sauce as also previously defined and described. For example, the soy sauce can be included in the wet pet food at a sufficient concentration to substantially offset visible oxidation that would otherwise be caused by oxygen and water permeability of the sealed pouch. The sealed pouch in this example can be constructed of a monomaterial of polypropylene as previously defined and described. In some examples, the monomaterial of polypropylene can be a monolayer of polypropylene. Preparing the wet pet food can include adding the soy sauce as dehydrated particulates at from about 0.1 wt % to about 3 wt % based on a total weight of the wet pet food. However, other modes of addition can also be used, such as adding the soy sauce as a liquid and/or a paste. However, it is noted that the concentration of soy sauce added by weight to the wet pet food is based on the dehydrated weight (or dry weight) of the soy sauce, regardless of how it is added. The soy sauce can be included with other antioxidants, but in some examples, the soy sauce can be included as the only antioxidant added. If, for example, the wet pet food is in the form of chunks-in-gravy, the chunks may be admixed with the gravy at a weight ratio from about 1:1 to about 1:4, or from about 2:3 to about 1:3. In this example, the gravy can include water, thickener, and the antioxidant (which includes at least the soy sauce). The other details regarding the wet pet food and the polypropylene pouch used in this method can be as described previously in the context of the wet pet food system, and that description and those related definitions are incorporated here by reference.

### Example Embodiments

In accordance with the disclosure herein, the following examples are

illustrative of several embodiments of the present technology.
1. An example wet pet food system, comprising:
a sealed pouch constructed of a monomaterial of polypropylene; and
a wet pet food contained within the sealed pouch, the wet pet food including a member selected from the group consisting of a mousse, a chunk-in-loaf, and chunks-in-gravy, wherein the wet pet food comprises an antioxidant including a soy sauce.
2. The wet pet food system of example 1, wherein the sealed pouch is recyclable.
3. The wet pet food system of any one of examples 1-2, wherein the sealed pouch is constructed of a monolayer of polypropylene.
4. The wet pet food system of any one of examples 1-3, wherein the sealed pouch is more permeable to oxygen and water than an aluminum barrier pouch.
5. The wet pet food system of any one of examples 1-4, wherein the soy sauce is included in the wet pet food at from about 0.1 wt % to about 3 wt % based on dehydrated soy sauce weight within a total weight of the wet pet food.
6. The wet pet food system of any one of examples 1-5, wherein the soy sauce is added to the wet pet food at from about 0.25 wt % to about 2 wt % based on dehydrated soy sauce weight within a total weight of the wet pet food.
7. The wet pet food system of any one of examples 1-6, wherein the wet pet food includes from about 40 wt % to about 80 wt % water based a total weight of the wet pet food.
8. The wet pet food system of any one of examples 1-7, wherein the wet pet food is shelf stable within the sealed pouch for at least about nine months.
9. The wet pet food system of any one of examples 1-8, wherein the wet pet food is in the form of the chunks-in-gravy, the chunks-in-gravy comprising chunks and a gravy present in the sealed pouch at a weight ratio from about 1:1 to about 1:4.
10. The wet pet food system of example 9, wherein the chunks and the gravy are present in the sealed pouch at a weight ratio from about 2:3 to about 1:3.
11. The wet pet food system of example 9, wherein the chunks include from about 30 wt % to about 80 wt % protein.
12. The wet pet food system of example 11, wherein the protein includes animal-based protein.
13. The wet pet food system of example 11, wherein the protein includes plant protein extract.
14. The wet pet food system of any one of examples 1-13, wherein the antioxidant consists essentially of the soy sauce.
15 The wet pet food system of any one of examples 1-14, wherein the wet pet food includes Maillard reaction precursors and catalyst.
16. A method of packaging wet pet food, comprising: preparing a wet pet food, the wet pet food including a member selected from the group consisting of a mousse, a chunk-in-loaf, and chunks-in-gravy, wherein the wet pet food comprises an antioxidant including a soy sauce; and enclosing the wet pet food within a sealed pouch constructed of a monomaterial of polypropylene.
17. The method of example 16, wherein the soy sauce is included in the wet pet food at a sufficient concentration to substantially offset visible oxidation that would otherwise be caused by oxygen and water permeability of the sealed pouch.
18. The method of any one of examples 16-17, wherein preparing the wet pet food includes adding the soy sauce as dehydrated particulates at from about 0.1 wt % to about 3 wt % based on a total weight of the wet pet food.
19. The method of any one of examples 16-18, wherein no other antioxidant is added to the wet pet food other than the soy sauce.
20. The method of any one of examples 16-19, wherein the wet pet food is in the form of the chunks-in-gravy and is prepared by admixing chunks with a gravy at a weight ratio from about 1:1 to about 1:4, wherein the gravy includes water, thickener, and the antioxidant.

### Definitions

The term “about” means plus or minus 10%; in another aspect, plus or minus 5%; and in one specific aspect, plus or minus 2%. For example, in one aspect where about is plus or minus 10% of a numeric value, the phrase “from about 5% to about 10%” could include a range from 6% to 8% or 7% to 10%, including any subranges therein. Furthermore, ranges here that include “about” therewith also expressly include the exact value notated. For example, the phrase “about 16 wt % or less” expressly supports a direct teaching of “16 wt % or less” as a subrange.

As used herein, “comprising” or “including” language or other open-ended language can be substituted with “consisting essentially of” and “consisting of” as if such transition phrase is expressly included in such examples.

The term “substantially” when referring to the absence of a component indicates that the material is not present in any concentration greater than trace amounts, such as amounts that might inherently be present as an impurity or in an amount that is low enough that it does not provide a function to which it is typically used. For example, a composition that includes a small amount of silicon dioxide flow aid that does not provide measurable flow enhancement could still considered to be “substantially devoid of silicon dioxide flow aid,” and particularly so if present in trace amounts. In some examples, a composition may be “substantially devoid” of a compound if it is present at less than about 0.05 wt %, or even less than about 0.01 wt %, for example.

All percentages expressed herein are by weight of the composition that is referenced based on a dry matter basis unless specifically stated otherwise. For example, a weight percentage of a component in a dried animal digest composition is based on a total weight of a dried animal digest composition. A weight percentage of a component of a pet food composition is based on a total weight of the pet food composition.

As used herein, ranges are in shorthand so as to avoid having to list and describe each and every value within the range. Any appropriate value within the range can be selected, where appropriate, as the upper value, lower value, or the terminus of the range, and thus should be interpreted flexibly to include the numerical values explicitly recited as the limits of the range, and also to include individual numerical values or sub-ranges encompassed within that range as if numerical values and sub-ranges are explicitly recited. As an illustration, a numerical range of “about 1 wt % to about 5 wt %” should be interpreted to include the explicitly recited values of about 1 wt % to about 5 wt %, and also to include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting one numerical value.

Furthermore, such an interpretation should apply regardless of the breadth of the range or the characteristics being described.

As used herein, the singular form of a word includes the plural, and vice versa, unless the context clearly dictates otherwise. Thus, the references “a,” “an,” and “the” are generally inclusive of the plurals of the respective terms. For example, reference to “a dried animal digest composition,” “the pet food composition,” “a method,” etc. includes a plurality of such dried animal digests, pet food compositions, methods, etc.

The term “example(s),” particularly when followed by a listing of terms, is merely exemplary and illustrative and should not be deemed to be exclusive or comprehensive.

The methods and compositions and other advances disclosed herein are not limited to particular methodology, protocols, and reagents described herein because, as the skilled artisan will appreciate, they may vary. Further, the terminology used herein is for the purpose of describing particular examples only, and is not intended to and does not limit the scope of that which is disclosed or claimed.

Unless defined otherwise, all technical and scientific terms, terms of art, and acronyms used herein have the meanings commonly understood by one of ordinary skill in the art in the field(s) of the invention, or in the field(s) where the term is used. Although compositions, methods, articles of manufacture, or other means or materials similar or equivalent to those described herein can be used in the practice of the present invention, certain compositions, methods, articles of manufacture, or other means or materials are described herein.

As used herein, a plurality of elements, compositional components, and/or materials may be presented in a common list for convenience. However, these lists should be construed as though individual members of the list are individually identified as separate and unique members. Thus, no individual member of such list should be construed as a de facto equivalent of any other member of the same list solely based on presentation in a common group without indications to the contrary.

### EXAMPLES

Features of the present disclosure can be further illustrated by the following examples, although it will be understood that these examples are included merely for purposes of illustration and are not intended to limit the scope of the invention unless otherwise specifically indicated.

### Example 1—Packaging Shelf-Life Study

A short shelf-life study of 9 months was conducted comparing a standard chunks-in-gravy recipe (grilled) carried by two types of sealed pouches, namely a recyclable pouch constructed of a monolayer of polypropylene and a standard multi-layered alu-pouch (which included a thin aluminum layer as an oxygen/water vapor barrier). The polypropylene pouch had a thickness of about 104 μm, an oxygen transmission value of 1.38 cc/m², and a water vapor transmission rate of about 1.22 g/m². The alu-pouch had a thickness of about 79 μm, an oxygen transmission value of 0.20 cc/m², and a water vapor transmission rate of about 0.01 g/m².

It was found that wet pet food products stored at room temperature within the two types of packaging performed differently. Specifically, the polypropylene pouch was less protective against oxidation of the wet pet food compared to the protection provided by the alu-pouch. For example, it was observed that there was an increased number of oxidized chunks within the polypropylene pouch compared to that of the wet pet food within the alu-pouch. Furthermore, there was a decrease in palatability performance of the chunks-in-gravy wet pet food when stored in the polypropylene pouch compared to the wet pet food stored in the standard alu-pouch, as determined by a short palatability test using 40 cats conducted over a period of 2 hours. Thus, it was determined that though the polypropylene pouch is a more desirable packaging for purposes of recyclability, it was inferior with respect to ameliorating oxidation and retaining good palatability.

Two studies were thus initiated by adding palatability enhancers and/or antioxidant(s) to maintain the palatability of the wet pet food and to reduce the oxidation of the chunks when stored within a polypropylene pouch over an extended shelf-life time frame.

### Example 2—Wet Pet Food Appearance and Palatability Screening

A wet pet food palatability trial was performed to screen various additive ingredients that could be used to enhance palatability. The wet pet food recipe included about 69/31 weight ratio of gravy to grilled chicken-based chunks. More specifically, the chunks-in-gravy formulations were based on the commercial product “Gourmet Mon Petit Chicken,” available in France by Purina® which is referred to in Table 1 as “Standard,” indicating that the recipe remained unchanged. Gravy variations 1-4 (VAR 1-4) shown in Table 1 below provide the added palatability ingredients tested for inclusion, as follows:

TABLE 1
Wet Food Appearance

| Gravy | Additive | Appearance |
|---|---|---|
| Standard* | None | Clearer Appearance |
| VAR 1† | 1 wt % Tomato Powder | Increased Orange |
| | | Appearance |
| | | Increased Liquidity |
| | | Tomato Flavor |
| VAR 2† | 1 wt % Dried Animal | Less Available Gravy |
| | Digest Powder | Cloudy Appearance |
| | | Sulfurous Odor |
| VAR 3† | 3.3 wt % Maillard Reaction | Cloudy Appearance |
| | Precursors (e.g., yeast, | Yeast Flavor |
| | sugar, and amino acid) | |
| VAR 4† | 1 wt % soy sauce powder | Very slightly darker |
| | (Kikkoman Dehydrated | than Standard |
| | Soy Sauce KS-20) | Increased Liquidity |

*Gourmet Mon Petit Chicken
†Gourmet Mon Petit Chicken, modified with Additive
As can be seen from Table 1, VAR 4 was the most similar in appearance to the Standard gravy.

### Example 3—Short-term Storage Screening in Polypropylene Pouches

Each of these wet pet food recipes described in Example 2 was separated into portions and packaged in multiple polypropylene pouches. The various pouches were stored at 20° C., 30° C., or 40° C. for one (1) month and the level of oxidation was evaluated by 12 trained panelists. The 12 panelists each opened two (2) pouches of each of the five (5) recipes at each of the three (3) storage temperatures. The criteria used in evaluating each of the samples was based on the quantity of perceived oxidized chunks (from 0 to 10, with 0 indicating no chunks oxidized and 10 indicating all chunks oxidized), the oxidation intensity (from 0 to 10, with 0 indicating no oxidation and 10 indicating strong color change), and color intensity (from 0 to 10, with 0 indicating very light chunks and 10 indicating dark chunks). Note that perceived oxidation is based on visible criteria and not on demonstrated chemical oxidation. Based on an average of the 12 panelists, a ranking of low, medium, high, and very high were assigned. The results are shown below in Table 2.

TABLE 2
Perceived Oxidation of Chunks

| | Degree of Perceived Oxidation | | |
|---|---|---|---|
| Gravy | 20° C. | 30° C. | 40° C. |
| Standard* | Medium | High | Very High |
| VAR 1† | Low | Low | Low |
| VAR 2† | Low | Medium | Medium |
| VAR 3† | Medium | High | Low |
| VAR 4† | Low | Low | Low |

*Gourmet Mon Petit Chicken
†Gourmet Mon Petit Chicken, modified with Additive of Table 1

As can be seen from Table 2, VAR 1 (tomato powder) and VAR 4 (soy sauce powder) exhibited the lowest perceived oxidation scores. However, in considering Table 1, the consistency and color of the wet pet food (particularly the gravy) aligned the closest with the Standard gravy, without the added tomato taste. Furthermore, based on results from this sensory analysis, palatability, and formulation complexity, the addition of the soy sauce proved to be the best approach in further studying the long term impact on oxidation and palatability compared to formulations that included proven antioxidant systems.

### Example 4—Sensory Perception Comparison of Wet Pet Food Systems at Various Storage Time Intervals Two wet pet food systems were prepared for comparative purposes.

Specifically, a first wet pet food system (Standard System) was prepared based on a grilled chunks-in-gravy wet pet food recipe contained in an alu-pouch (including a thin aluminum layer as an oxygen/water vapor barrier). The first wet pet food system was similar to the commercial product “Gourmet Mon Petit Chicken” available in France. A second wet pet food system (Soy-PP System) was prepared using the same wet pet food recipe, except that about 1 wt % of Kikkoman Dehydrated Soy Sauce KS-20 was added to the gravy of the wet pet food and the sealed pouch selected for use was a polypropylene monolayer pouch. As described in Example 1, the oxygen transmission value and the water vapor transmission rate of the polypropylene pouch were significantly greater than these values were for the alu-pouch.

With these two systems prepared, a shelf-life study was conducted to compare various sensory perception properties of both the Standard System with the Soy-PP System prepared in accordance with the present disclosure. Multiple pouches of each of the systems were stored at room temperature, with portions of each being opened at 2 months, 3 months, 6 months, and 9 months for inspection by 12 trained panelists. More specifically, 12 panelists each opened two (2) pouches of each system and characterized aroma (level of cook, cereals, and off aroma), gravy color intensity, gravy homogeneity and thickness, proportion of oxidized meat chunks and the intensity of the oxidation (color difference between the oxidized chunks and those not oxidized). The results of the sensory perception comparison were based on a scale of 0-10, and sensory perception scores are shown in Table 3, as follows:

TABLE 3
Sensory Perception of Chunks vs. Storage Durations

| | Storage | Amount | Oxidation | Color |
|---|---|---|---|---|
| System | Time | Oxidized | Intensity | Intensity |
| Standard* | 2 Mo. | 2 | 1.3 | 5.2 |
| | 3 Mo. | 1.8 | 1.6 | 5.1 |
| | 6 Mo. | 2 | 1.6 | 5.4 |
| | 9 Mo. | 1.4 | 1.5 | 4.9 |
| VAR 4† | 2 Mo. | 2.1 | 1.7 | 5.7 |
| (Soy-PP) | 3 Mo. | 2 | 1.5 | 5.7 |
| | 6 Mo. | 2.2 | 1.8 | 6.3 |
| | 9 Mo. | 1.6 | 1.8 | 5.7 |

*Gourmet Mon Petit Chicken
†Gourmet Mon Petit Chicken, modified with 1 wt % soy sauce powder
Values Rounded to nearest 0.1

As can be seen in Table 3, based on the 0-10 sensory perception scale, there was not a significant difference between the Standard wet pet food system and the Soy-PP wet pet food system, with all scores being separate by less than a score of one (1) at all time intervals, and in many cases the separation was negligible. Furthermore, like the screening evaluation conducted in Example 2, the chunks with soy sauce recipe (VAR 4) appeared slightly darker than the chunks in the Standard gravy.

### Example 5—Palatability Comparison of Standard Wet Pet Food Recipe in Alu-Pouch vs. Wet Pet Food with Soy Sauce in Polypropylene Monolayer Pouch

The same two wet pet food systems as described in Example 4 were evaluated for palatability, namely the Standard wet pet food system and the VAR 4 (Soy-PP) wet pet food systems. To evaluate palatability, 40 cats were used and given a two-bowl test, with one bowl containing the wet pet from the Standard wet pet food system and one bowl containing the wet pet food from the Soy-PP wet pet food system. Each bowl included a full serving of the wet pet food, and the cats were given the option to eat from either bowl. The percentage of consumption from each bowl was measured to see if there was a preference for one of the wet pet food recipes over the other after various storage periods at room temperature. The storage periods for this study were 1 month, 3 months, 6 months, and 9 months. Table 4 provides the data collected at all time intervals, as follows:

TABLE 4
Preference vs. Storage Duration of Polypropylene
Pouch Wet Pet Food Systems

| Storage Time | Standard (% Preference) | VAR4 (% Preference) |
|---|---|---|
| 1 Mo. | 46 | 54 |
| 3 Mo. | 47 | 53 |
| 6 Mo. | 55 | 45 |
| 9 Mo. | 50 | 50 |

As can be seen in Table 4, there was no significant difference in preference between the wet pet food from the Standard wet pet food system compared to the wet pet food from the Soy-PP pet food system, including at 9 months of storage time where the results were split evenly.

### Example 6—Shelf-Life Comparison of Four Wet Pet Food Systems

A nine (9) month, room temperature shelf-life study was conducted comparing three (3) different wet pet food systems to confirm that the combination of the addition of soy sauce added to a wet pet food recipe contained in a monolayer polypropylene pouch would outperform other recipes contained in the same type of pouch. The first wet pet food system included a wet pet food recipe similar to the commercial product “Gourmet Mon Petit Chicken,” available in France by Purina®, but in this instance was packaged in the polypropylene pouch. The second wet pet food system included a sealed polypropylene pouch containing the Gourmet Mon Petit Chicken wet pet food recipe with an antioxidant package added to the gravy that included about 0.07 wt % organic antioxidants, e.g., organic acid and vitamins (including Vitamin C and E), about 1 wt % of meat protein hydrolysate, and about 1.4 wt % Maillard reaction precursors, e.g., amino acid and monosaccharide. The third wet pet food system included a sealed polypropylene pouch containing the Gourmet Mon Petit Chicken wet pet food recipe with 1 wt % of Kikkoman Dehydrated Soy Sauce KS-20 added to the gravy. As a comparative, the Gourmet Mon Petit Chicken was also tested as commercially available, which included a standard alu-pouch. The polypropylene pouches and the alu-pouches were as described in Example 1. After the nine (9) month storage period, the packages were opened and evaluated to determine the level of oxidation of the grilled chunks in the gravy by counting the number of oxidized chunks relative to the total number of chunks (% oxidized by count) that were contained in the opened pouches. The percentages were based on averages over the entire population of cats evaluated, and the results are provided in Table 5, as follows:

TABLE 5
Shelf-life Comparison of Oxidized Chunks in Various
Wet Pet Food Systems

| Type of Pouch | Alu-pouch | Polypropylene | | |
|---|---|---|---|---|
| Wet Pet Food Recipe | Standard* | Standard* | Antioxidant† | Soy Sauce† |
| Average Percent | 11-14% | 25% | 31% | 16% |
| Oxidation | | | | |
| (by Count) | | | | |

*Gourmet Mon Petit Chicken
±Gourmet Mon Petit Chicken, modified with 2.47 wt % antioxidant package
†Gourmet Mon Petit Chicken, modified with 1 wt % soy sauce powder

As can be seen from Table 5, the percentage of oxidized chunks in the polypropylene pouch when the wet pet food recipe is modified to include soy sauce is about the same as the

Standard wet pet food recipe contained in the alu-pouch, which is much more oxygen and water vapor impermeable than the polypropylene pouch. When no antioxidant is added to the Standard wet pet food recipe contained in the polypropylene pouch, the oxidation was considerably higher. Surprisingly, the 2.47 wt % antioxidant package, which was expected to perform the best due to its known antioxidant properties (e.g., vitamin E, vitamin C, organic acids, meat hydrolysates, etc.), had a negative impact on the oxidation of the chunks packaged in the polypropylene pouch. Thus, the soy sauce additive provided an unexpected antioxidant property with wet pet food that contained the polypropylene pouch. Furthermore, as illustrated above in Example 5, the soy sauce additive was also highly palatable to animals that were fed a similar wet pet food recipe.

In the specification, there have been disclosed certain embodiments of the invention. Although specific terms are employed, they are used in a generic and descriptive sense only and not for purposes of limitation. The scope of the invention is set forth in the claims. Many modifications and variations of the invention are possible in light of the above teachings. It is therefore to be understood that within the scope of the appended claims. the invention may be practiced otherwise than as specifically described.

What is claims is:

1. A wet pet food system, comprising:
a sealed pouch constructed of a monomaterial of polypropylene; and
a wet pet food contained within the sealed pouch, the wet pet food including a member selected from the group consisting of a mousse, a chunk-in-loaf, and chunks-in-gravy, wherein the wet pet food comprises an antioxidant including a soy sauce.

2. The wet pet food system of claim 1, wherein the sealed pouch is recyclable.

3. The wet pet food system of claim 1, wherein the sealed pouch is constructed of a monolayer of polypropylene.

4. The wet pet food system of claim 1, wherein the sealed pouch is more permeable to oxygen and water than an aluminum barrier pouch.

5. The wet pet food system of claim 1, wherein the soy sauce is included in the wet pet food at from about 0.1 wt % to about 3 wt % based on a dehydrated soy sauce weight of a total weight of the wet pet food.

6. The wet pet food system of claim 1, wherein the soy sauce is added to the wet pet food at from about 0.25 wt % to about 2 wt % based on a dehydrated soy sauce weight of a total weight of the wet pet food.

7. The wet pet food system of claim 1, wherein the wet pet food includes from about 40 wt % to about 80 wt % water based a total weight of the wet pet food.

8. The wet pet food system of claim 1, wherein the wet pet food is shelf stable within the sealed pouch for at least about nine months.

9. The wet pet food system of claim 1, wherein the wet pet food is in the form of the chunks-in-gravy, the chunks-in-gravy comprising chunks and a gravy present in the sealed pouch at a weight ratio from about 1:1 to about 1:4.

10. The wet pet food system of claim 9, wherein the chunks and the gravy are present in the sealed pouch at a weight ratio from about 2:3 to about 1:3.

11. The wet pet food system of claim 9, wherein the chunks include from about 30 wt % to about 80 wt % protein.

12. The wet pet food system of claim 11, wherein the protein includes animal-based protein.

13. The wet pet food system of claim 11, wherein the protein includes plant protein extract.

14. The wet pet food system of claim 1, wherein the antioxidant consists essentially of the soy sauce.

15. The wet pet food system of claim 1, wherein the wet pet food includes Maillard reaction precursors and catalyst.

16. A method of packaging wet pet food, comprising:
preparing a wet pet food, the wet pet food including a member selected from the group consisting of a mousse, a chunk-in-loaf, and chunks-in-gravy, wherein the wet pet food comprises an antioxidant including a soy sauce; and
enclosing the wet pet food within a sealed pouch constructed of a monomaterial of polypropylene.

17. The method of claim 16, wherein the soy sauce is included in the wet pet food at a sufficient concentration to substantially offset visible oxidation that would otherwise be caused by oxygen and water permeability of the sealed pouch.

18. The method of claim 16, wherein preparing the wet pet food includes adding the soy sauce as dehydrated particulates at from about 0.1 wt % to about 3 wt % based on a total weight of the wet pet food.

19. The method of claim 16, wherein no other antioxidant is added to the wet pet food other than the soy sauce.

20. The method of claim 16, wherein the wet pet food is in the form of the chunks-in-gravy and is prepared by admixing chunks with a gravy at a weight ratio from about 1:1 to about 1:4, wherein the gravy includes water, thickener, and the antioxidant.
